(19) United States
(12) Patent Application Publication
(10) Pub. No.: US 2009/0200110 A1
(43) Pub. Date: Aug. 13, 2009

(54) LADDER ANTI-SLIP PLATFORM

(76) Inventor: Donald Esselborn, Trafalgar, IN (US)

Correspondence Address: Kenneth Bower, 314 Ironstone Lane, Elverson, PA, 19520, US

(21) Appl. No.: 12/253,989

(22) Filed: Oct. 19, 2008

Related U.S. Application Data
(60) Provisional application No. 61/006,961, filed on Feb. 8, 2008.

(51) Int. Cl. E06C 7/46

(52) U.S. Cl. 182/107

(57) ABSTRACT

A system of ladder accessories that enhance the resistance of an extension ladder from slipping on a wide range of support surfaces is disclosed. The invention provides anti-slip surfaces for gripping to hard, granular, smooth, porous, non-porous and irregular ladder supporting surfaces using light and easy to carry ladder accessories. The system also includes ladder stabilizers that reduce the horizontal forces acting upon the anti-slip surfaces for further resistance to slipping.

### CROSS-REFERENCE TO RELATED APPLICATIONS.

The present application claims the benefit of U.S. Provisional Application No. 61/006,961, filed Feb. 8, 2008.

### STATEMENT REGARDING FEDERALLY SPONSORED RESEARCH OR DEVELOPMENT.

NOT APPLICABLE

### THE NAMES OF THE PARTIES TO A JOINT RESEARCH AGREEMENT.

NOT APPLICABLE

### INCORPORATION-BY-REFERENCE OF MATERIAL SUBMITTED ON A COMPACT DISC.

NOT APPLICABLE

### BACKGROUND OF THE INVENTION

1. Field of the Invention

Painters, construction workers and home owners find the extension ladder a convenient means of working on areas that are too high to reach both inside and outside of buildings.

Where ever the need arises, the extension ladder is erected on the horizontal support surface and leans against vertical surface that is available in that location often despite the unsuitable condition of the surfaces that are available.

An extension ladder that is properly set up has the bulk of the force of gravity acting on the horizontal supporting surface producing a frictional force that acts to prevent slipping of the ladder. The remainder of the gravitational force creates a rotational force on the ladder about the base of the ladder. The vertical wall resists the rotational force and an equal and opposite frictional force is generated between the ladder base and the horizontal supporting surface. Should the force resisting the rotational force against the wall exceed the frictional force at the base of the ladder the ladder will slip and fall.

Everyone using a step ladder for any length of time has used tent stakes, nails, twine, bungee cords, rope, trouser belts, bricks, cinder blocks, mop handles, wall studs, wood scraps, car bumpers or lawn tractors to resist ladder slipping and most have spent hours looking for and rigging up these contraptions and still many can recall the close calls they have experienced despite their efforts.

2. Description of Related Art

There are three ways to increase the anti-slipping performance of the extension ladder:

1) Decreasing the angle of the ladder measured from vertical by extending the ladder or by moving the base closer to the vertical surface.

2) Increasing the coefficient of friction between the ladder base and the horizontal surface material.

3) Shifting the effective point of resistance of the gravitational force to a point nearer to the vertical surface using a stabilizer somewhere along the height of the ladder.

Although these principles are well known, the patent art is cluttered with devices that improve the anti-slipping performance of ladders under limited situations. The Achilles heel of the state of the art is that no one device adapts to the vast majority of extension latter conditions ranging from granular soil, crushed stone, concrete, asphalt, plywood, planks, hard wood and ceramic materials that could cause slipping, nor are the devices portable and easy to carry around the job site.

1) Prior Art,

The published patent application of Caldwell, US 2005/0092551, discloses separate frictional surfaces for each upright of an extension ladder. The frictional surfaces are not under the uprights and must act without the benefit of the force of gravity from the user or ladder pressing the anti-slip surface against the support surface. This configuration is only effective on the smoothest, non-porous surfaces that could sustain suction in the suction cups.

The published patent application to Robinson, US 2006/0124393, discloses a single platform with a handle for portability but uses multiple spikes protruding from the bottom surface that would not be useable inside a building for risk of damaging the floors. The spikes are driven into the ground in a direction perpendicular to the support surface which is not the most affective at preventing slipping.

The patent to Harvey et al., U.S. Pat. No. 4,798,263 discloses stabilizer devices for an extension ladder. The stabilizers as disclosed move the effective base of the ladder very little closer to the vertical support surface and therefore have only a small affect on the likelihood of the ladder base slipping on the horizontal surface.

The published patent application to Proulx, US 2006/0231333 discloses a ladder stabilizer that is suited for use when working over a gutter but has little application when leaning the ladder against a vertical surface.

The published patent application to Hrincu, US 2002/0056591 discloses ladder stabilizers that have the height and extend substantially from the base of the ladder to resist sliding of the base of the ladder. However, the stabilizer height must be individually adjusted making it difficult to equalize the pressure between the stabilizers and the ground presenting the possibility of sideways movement of the ladder as the user ascends.

Although all of the aforementioned inventors are attacking the same problem over a period exceeding a half century they fail to adequately address the full breadth of the problem that requires a solution to portability and providing anti-slip surfaces for gripping to hard, granular, smooth, porous, non-porous and irregular extension ladder supporting surfaces.

### BRIEF SUMMARY OF THE INVENTION

The ultimate objective of the present invention is to provide a more effective and versatile anti-slip interface between the bottom of an extension ladder and the horizontal surfaces supporting the ladder.

An object of the present invention is to compensate for the user erecting the ladder with an uneven pressure between the uprights or feet and the horizontal surface supporting the ladder.

A further objective of the present invention is to resist slippage on solid, granular, smooth, porous, non-porous and irregular ladder supporting surfaces,

A further objective of the present invention is to provide the aforementioned functions in a portable, easy to carry package,

A further objective of the present invention is to be compact and easy to transport, stack and stow,

A further objective of the present invention is to be rugged with redundant frictional components so that damage to the frictional components can be sustained without significantly compromising function,

A further objective of the present invention is to provide a ladder stabilizer that supports the ladder from a position closer to the vertical support surface than the position of the ladder base to reduce the tendency of the ladder to slip,

A further objective of the present invention is to provide a ladder stabilizer that has one height adjustment so that user error can not make the stabilizer ineffective,

A further objective of the current invention is to provide a single stabilizer that can rest on the horizontal support surface or an elevated substantially horizontal surface such as a roof,

A further object is to attach the stabilizer to the ladder support platform to increase stability and make it easier to shift the ladder and stabilizer together along a wall,

The preferred embodiment of the present invention achieves the above objectives by applying a multiplicity of suction cups ideally suited for gripping hard, smooth and non-porous support surfaces. The suction cups are also manufactured from materials that exhibit a high friction coefficient with porous or irregular surfaces that do not hold a suction in the suction cup,

The preferred embodiment also achieves resistance to slippage with granular surfaces such as soil or crushed stone by applying sharp protrusions that extend beyond the bottom surface of the suction cups. The sharp protrusions are applied at an angle to the horizontal support surface to optimize slip resistance. Further the sharp protrusions are stored in the platform to assure availability when needed,

A first alternative embodiment applies a smooth frictional surface or a surface with multiple ribs, treads or protruding nibs that can be effective in gripping to irregular surfaces such as planks, hard wood finished flooring, concrete or plywood sub flooring. This additional surface can be employed in combination with the suction cups on the same surface of the platform.

A second alternative embodiment can combine the features of the preferred or first alternative embodiment by combining one or two different materials to each of the two platform surfaces to adapt the present invention to a wide variety of additional applications. Alternative surfaces are located on either side of the platform so that they are always available and easily used. The surfaces include a flat resilient surface, one dimensional tread design that resists movement in two opposing directions,

The three basic embodiments are combined with ladder stabilizers, pointed protrusions and a platform extension, yielding a system that meets all of the aforementioned objectives.

### BRIEF DESCRIPTION OF THE SEVERAL VIEWS OF THE DRAWING(S)

FIG. 1a. A perspective view of the preferred embodiment of the present invention with one anti-slip material that is shown supporting an extension ladder,

FIG. 1b. A perspective view of a variant on the preferred embodiment of the present invention affecting anti-slip performance,

FIG. 1c, A perspective view of a second variant on the preferred embodiment of the present invention affecting platform weight and stowage space,

FIG. 1d, A perspective view of a third variant on the preferred embodiment of the present invention further affecting anti-slip performance,

FIG. 2a, A perspective view of a second embodiment of the present invention further affecting anti-slip performance and portability,

FIG. 2b, A perspective view of a variant on the second embodiment of the present invention facilitating ladder use with multiple support surfaces,

FIG. 2c, A perspective view of a second variant on the second embodiment of the present invention affecting ease of use,

FIG. 2d, A perspective view of the third variant on the second embodiment of the present invention further addressing anti-slip performance on a variety of support surfaces,

FIG. 3a, A perspective view of a third embodiment of the present invention further affecting anti-slip performance on a variety of support surfaces,

FIG. 3b. A perspective view of a variant on the third preferred embodiment of the present invention affecting anti-slip performance,

FIG. 3c, A perspective view of a second variant on the third embodiment of the present invention affecting weight and stowage space,

FIG. 3d, A perspective view of a third embodiment of the present invention further affecting anti-slip performance on a variety of support surfaces,

FIG. 3e, A perspective view of a third embodiment of the present invention further affecting anti-slip performance on a variety of support surfaces,

FIG. 3f, A perspective view of a third embodiment of the present invention further affecting anti-slip performance on a variety of support surfaces,

FIG. 3g, A perspective view of a third embodiment of the present invention further affecting anti-slip performance on a variety of support surfaces,

### DETAILED DESCRIPTION OF THE INVENTION.

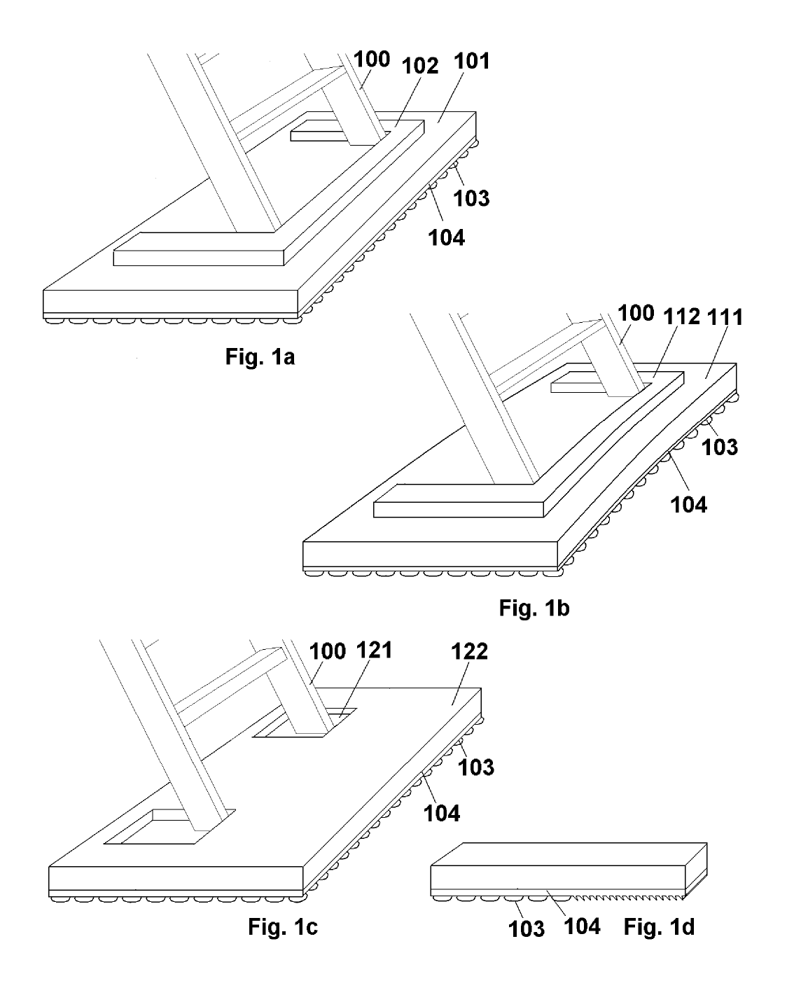

The series of drawings FIG. 1a to FIG. 1d constitute the preferred embodiment of the present invention.

FIG. 1a, shows an extension ladder 100, that is being supported by platform 101 that is wider than the base of the extension ladder 100. The abutment 102 keeps the ladder from sliding off of the platform 101 in a direction parallel to ladder rung 110 and also in a direction perpendicular to ladder rung 110. Anti-slip material 104 has a plurality of suction cups 103 on the bottom surface and is attached to the bottom face of platform 101. The suction cups 103 provide good anti-slip performance with flat, non-porous support surfaces (un-shown) that are particularly slippery. Being made of a resilient material of high friction coefficient, the suction cups provide good anti-slip performance on porous and irregular surfaces even though no suction is developed.

FIG. 1b, shows ladder 100, supported by anti-slip material 104 that has a plurality of suction cups 103 on the bottom surface much like FIG. 1. However, the lower face of the platform 111 and the abutment 112 are curved upward from the supporting surface at the center of the platform 111. This configuration assures contact between the suction cups 104 and the supporting surface (un-shown) towards the edges running perpendicular to the ladder rung 110. This contact resists angular sliding of the platform 111. The curvature of the base 111 assists the release of the suction cups from particularly smooth, non-porous support surfaces (un-shown).

FIG. 1c, again shows ladder 100, supported on anti-slip material 104 and suction cups 103, much like FIG. 1a. However, the abutment that limits motion between the ladder 100 and platform 122 is formed with recesses 121 to reduce the weight of the platform and also the space required to stow the platform in the painters vehicle (un-shown).

FIG. 1d, shows that more than one anti-slip material and or type of anti-slip surface configuration can be combined, suction cups 103 and two dimensional tread 105 are shown, to adapt the present invention to combinations of support surfaces (un-shown).

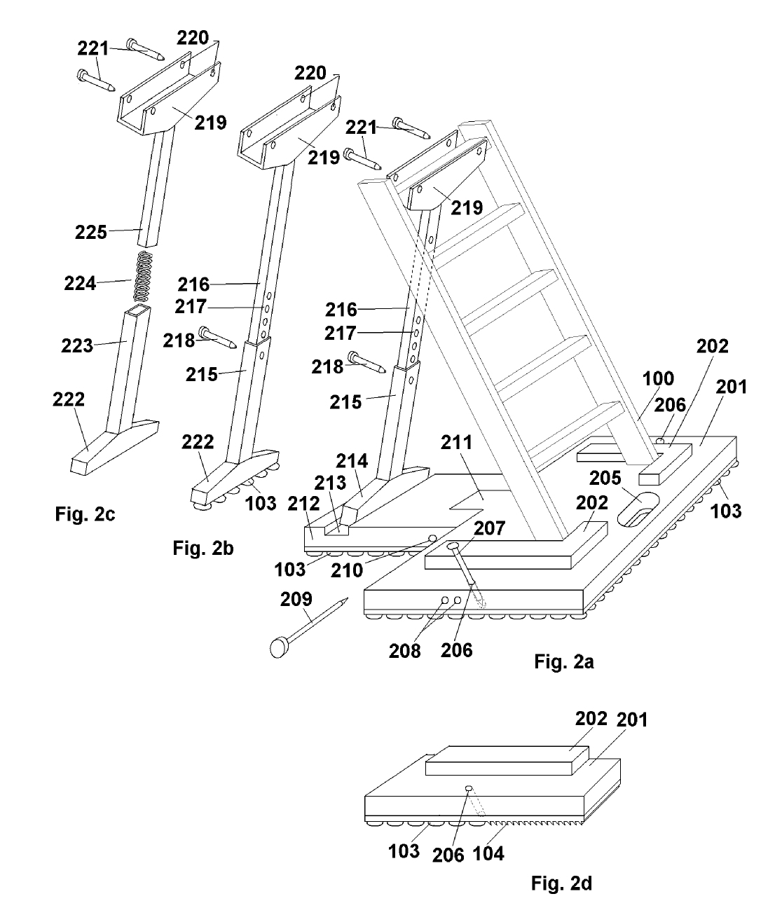

The series of drawings FIG. 2a to FIG. 2c show a second preferred embodiment of a ladder anti-slip system based on the principles of the preferred embodiment that broaden the application of the ladder to a variety of support surfaces and improve portability.

FIG. 2a, adds a pointed protrusion 206 that slides in a hole in the platform that is slanted so that the pointed protrusion is essentially parallel to the uprights of the ladder 100 providing enhanced anti-slip performance on granular surfaces such as soil or gravel. Receptacles 208 for storing un-used pointed protrusions 206 are also provided. A handle 205 has been added for ease of carrying the system to the job site. Lastly, a connector 211 and a platform extension 212 has been added to support ladder stabilizer 216. Platform extension 212 has suction cup 103 or any other suitable anti-slip surface on the bottom face. Platform extension 212 also has abutment 113 to limit motion of the ladder stabilizer 216. Pin 209 pivotally connects platform extension 212 to platform 201 by engagement with through hole 210. Ladder stabilizer 216 is pivotally attached to a rung of the ladder 100 by means of retainers 221 engaging into the holes in upper yoke 219. The ladder stabilizer base 214 engages the platform extension 212 at abutment 213 and is adjusted lengthwise by engagement of key 218 with through holes 217.

FIG. 2b is a variant on FIG. 2a where ladder stabilizer 216 is supported directly on the supporting surface (un-shown) without the use of a platform extension.

FIG. 2c is a variant on the devices of FIG. 2a and FIG. 2b, that provides a height adjustment by means of a resilient member 224. This device can either be supported directly on the supporting surface like the device of FIG. 2b or by a platform extension like the device of FIG. 2a.

FIG. 2d shows application of the pointed protrusion 206 to a platform 201 having two anti-slip materials 103 and 105.

The series of drawings 3a to 3g show a ladder anti-slip system based on the principles of the preferred embodiment that further broaden the use of the ladder into more difficult environments.

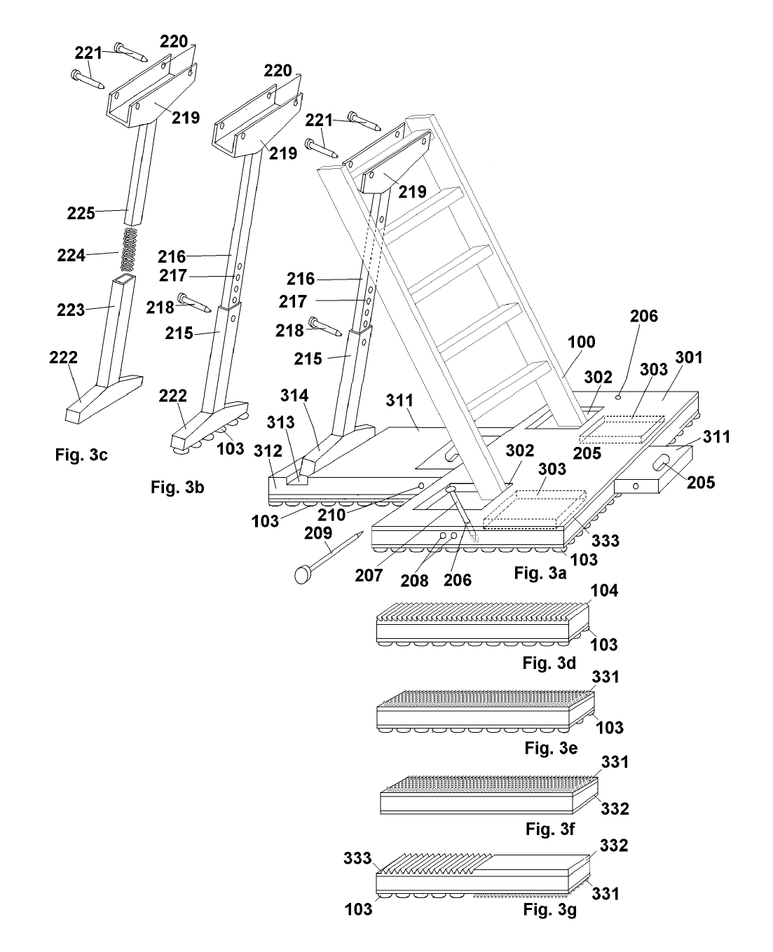

FIG. 3a shows a ladder platform much like the earlier two embodiments. The abutment 302 that limits relative motion between the ladder 100 and the platform 301 is recessed below the upper face of the platform 301. A second set of abutment recesses 303 are provided on the bottom face of the platform 301. There is also a connector 311 to facilitate attachment of a platform extension on either edge of the platform 301. These modifications on the second preferred embodiment provide a bottom face 104 of the platform 301 where anti-slip material 103 can be attached and an upper face of the ladder platform 301 where a second anti-slip material 333 can be attached.

FIG. 3a, also adds a pointed protrusion 206 that slides in a hole in the platform that is slanted so that the pointed protrusion is essentially parallel to the uprights of the ladder 100 providing enhanced anti-slip performance on granular surfaces such as soil or gravel. Receptacles 208 for storing un-used pointed protrusions 206 are provided. A handle 205 has been added for ease of carrying the system to the job site. Lastly, a connector 211 and a platform extension 212 has been added to support ladder stabilizer 216. Platform extension has suction cup 103 or any other suitable anti-slip surface on the bottom face and abutment 113 to limit motion of the ladder stabilizer 216. Pin 209 pivotally connects platform extension 212 to platform 201 by engagement with through hole 210. Ladder stabilizer 216 is pivotally attached to a rung of the ladder 100 by means of retainers 221 engaging into the holes in upper yoke 219. The ladder stabilizer base 214 engages the platform extension 212 at abutment 213 and is adjusted lengthwise by engagement of key 218 with through holes 217.

FIG. 3b is a variant on FIG. 3a where ladder stabilizer 216 is supported directly on the supporting surface (un-shown) without the use of a platform extension.

FIG. 3c is a variant on the devices of FIG. 3a and FIG. 3b, that provides a height adjustment by means of a resilient member 224. Another advantage of this configuration is to equalize the weight being carried by the ladder uprights and the ladder stabilizer. This device can either be supported directly on the supporting surface like the device of FIG. 3b or by a platform extension like the device of FIG. 2a.

FIG. 3d shows how a tread having a surface pattern 104 running in a single direction can be attached to the top face of the ladder platform 301 while suction cup anti-slip material 103 is fastened to the bottom face.

FIG. 3e shows how anti-slip material having a surface pattern 331 running in two directions can be attached to the top face of the ladder platform 301 while un-patterned anti-slip material 103 is fastened to the bottom face.

FIG. 3f shows how anti-slip material having a surface pattern 331 running in two directions can be attached to the top face of the ladder platform 301 while suction cup anti-slip material 332 is fastened to the bottom face.

FIG. 3g shows how anti-slip material having a surface pattern 331 running in two directions and suction cup anti-slip material 103 can be attached to the bottom face of the ladder platform 301 while single direction surface pattern 333 and un-patterned anti-slip material 332 are fastened to the top ladder platform faces as an illustration that any number of combinations are possible in this embodiment of the current invention.

While the description of the preferred embodiment and two additional embodiments shows a number of specific implementations of the basic principles of the current invention it is understood that one of ordinary skill could modify such in a way that remains within the spirit and meets and bounds of the current invention.

1. An apparatus for supporting a ladder comprising:
a platform that has an essentially planar bottom face,
wherein a platform edge runs essentially parallel to one or more rungs of the ladder and exceeds the width of the ladder,
an abutment for limiting relative motion between the ladder and the platform in a direction normal to the rungs of the ladder,
one or more anti-slip surfaces substantially covering a bottom face of the platform for contact with a supporting surface,
wherein at least one of the anti-slip surfaces is comprised of resilient materials with a high coefficient of friction with the supporting surface,

2. The apparatus of claim 1, wherein:
at least one anti-slip surface is shaped for holding a negative pressure with the supporting surface,

3. The apparatus of claim 1, wherein:
at least one anti-slip surface has one or more protruding structures that extend into irregularities in the supporting surface,

4. The apparatus of claim 1, wherein:
the bottom face of the platform is curved to facilitate relieving the negative pressure with the supporting surface between uses,

5. The apparatus of claim 1, further comprising:
one or more through holes at an angular relationship with the bottom face and having an axis that is essentially parallel to one or more uprights of the ladder,

6. The apparatus of claim 1, further comprising:
an extensible ladder stabilizer that is attached to a rung of the ladder, the extensible ladder stabilizer extending between the rung of the ladder and the supporting surface,

7. The apparatus of claim 7, further comprising:
a resilient member in the extensible ladder stabilizer.

8. An apparatus for supporting a ladder comprising:
a platform that has an essentially planar bottom face,
wherein a platform edge runs essentially parallel to one or more rungs of the ladder and exceeds the width of the ladder,
an abutment for limiting relative motion between the ladder and the platform in a direction normal to the rungs of the ladder,
one or more anti-slip surfaces substantially covering a bottom face of the platform for contact with a supporting surface,
a platform extension connected to allow relative motion with the platform,
one or more anti-slip surfaces substantially covering a bottom face of the platform extension for contact with the supporting surface,
an abutment for limiting relative motion between a ladder stabilizer and the platform extension,

9. The apparatus for supporting a ladder of claim 8, further comprising:
an extensible ladder stabilizer that is attached to a rung of the ladder, wherein the extensible ladder stabilizer extends between the rung of the ladder and the platform extension,

10. The apparatus of claim 9, further comprising:
a resilient member in the extensible ladder stabilizer.

11. An apparatus for supporting a ladder comprising:
a platform that has an essentially planar bottom face and
an essentially planar top face,
a platform edge that runs essentially parallel to one or more rungs of the ladder and exceeds the width of the ladder,
an abutment for limiting relative motion between the ladder and the platform in a direction normal to the rungs of the ladder,
one or more anti-slip surfaces substantially covering the essentially planar bottom face of the platform for contact with a supporting surface,
one or more anti-slip surfaces substantially covering the essentially planar top face of the platform for contact with the supporting surface when the platform is turned up side down,

12. The apparatus of claim 11, further comprising:
an extensible ladder stabilizer that is attached to a rung of the ladder, wherein the extensible ladder stabilizer extends between the rung of the ladder and the supporting surface,

13. The apparatus of claim 12, further comprising:
a resilient member in the extensible ladder stabilizer.

15. The apparatus for supporting a ladder of claim 11, further comprising:
a platform extension connected to allow relative motion with the platform,
one or more anti-slip surfaces substantially covering a bottom face of the platform extension for contact with the supporting surface,
an abutment for limiting relative motion between a ladder stabilizer and the platform extension,

16. The apparatus of claim 11, further comprising:
an extensible ladder stabilizer that is attached to a rung of the ladder, wherein the extensible ladder stabilizer extends between the rung of the ladder and the supporting surface,

17. The apparatus of claim 16, further comprising:
a resilient member in the extensible ladder stabilizer.

18. The apparatus of claim 11, wherein:
at least one anti-slip surface is shaped for holding a negative pressure with the supporting surface,

19. The apparatus of claim 11, wherein:
at least one anti-slip surface has protruding structures that extend into irregularities in the supporting surface,

20. The apparatus of claim 11, further comprising:
one or more through holes disposed at an angular relationship with the essentially planar bottom face and having an axis that is essentially parallel to one or more uprights of the ladder,
